(19) United States
(12) Patent Application Publication
(10) Pub. No.: US 2024/0163872 A1
(43) Pub. Date: May 16, 2024

(54) PARTIAL BANDWIDTH RADIO TRANSMISSION METHOD AND DEVICE, BASE STATION AND USER EQUIPMENT

(71) Applicant: SPREADTRUM COMMUNICATIONS (SHANGHAI) CO., LTD., Zhangjiang Shanghai (CN)

(72) Inventors: Huayu ZHOU, Zhangjiang Shanghai (CN); Yanan JIA, Zhangjiang Shanghai (CN); Wenqiang TIAN, Zhangjiang Shanghai (CN)

(21) Appl. No.: 18/409,883

(22) Filed: Jan. 11, 2024

Related U.S. Application Data
(63) Continuation of application No. 15/928,614, filed on Mar. 22, 2018.

(30) Foreign Application Priority Data
Mar. 24, 2017 (CN) 201710184558.3

(51) Int. Cl. H04W 72/1273; H04L 5/00; H04W 72/0453; H04W 72/23; H04W 72/51

(52) U.S. Cl. CPC H04W 72/1273; H04L 5/0005; H04L 5/0048; H04L 5/0053; H04W 72/0453; H04W 72/23; H04W 72/51

(57) ABSTRACT

Partial bandwidth radio transmission method and device, base station and user equipment are provided. The method includes: configuring a first common control channel transmitted on an anchor sub-band; configuring at least one sub-band other than anchor sub-bands, and a second common control channel transmitted on the at least one sub-band; scheduling at least one partial bandwidth UE to the at least one sub-band, and transmitting configuration of the second common control channel and the at least one sub-band to the at least one partial bandwidth UE; and obtaining a transmission time of a synchronization signal block in the anchor sub-band, and transmitting the second common control channel to the at least one sub-band based on the transmission time, wherein the second common control channel includes a reference signal for demodulation. UE can receive and transmit data using partial bandwidth among a relatively large system bandwidth, which improves system efficiency.

### CROSS-REFERENCE TO RELATED APPLICATIONS

The present application is a continuation of U.S. patent application Ser. No. 15/928,614, filed Mar. 22, 2018, the entire contents of which are incorporated herein by reference. The Ser. No. 15/928,614 application claimed the benefit of the date of the earlier filed Chinese Patent application No. 200710184558.3, filed on Mar. 24, 2017, priority of which is also claimed herein, and the contents of which are also incorporated by reference herein.

### TECHNICAL FIELD

The present disclosure generally relates to radio communication technology field, and more particularly, to partial bandwidth radio transmission method and device, a base station and a user equipment.

### BACKGROUND

In present 5G systems, system bandwidth of a single carrier increases significantly. For example, the single carrier may have bandwidth of 100 MHz under a frequency band less than 6 GHz. User Equipment (UE) can use the bandwidth of 100 MHz directly, however, this may result in operation under relatively high sampling rates, such as 153.6 Msps, which further leads to high power consumption. In some scenarios, UE may receive and transmit data using relatively narrow bandwidth, such as transmission of small data packets, in a power saving mode, or the UE being a low-cost terminal. In these scenarios, the UE can use relatively narrow bandwidth, such as 20 MHz, and accordingly, its sampling rate drops significantly, such as 30.72 Msps.

In an idle state, narrowband UEs (also called non-full-bandwidth UEs or partial bandwidth UEs) camp on anchor sub-bands. When the narrowband UEs enter a connection state, a network may assign them to other sub-bands. For load balance of all the sub-bands, the network should allocate narrowband UEs to the other sub-bands as evenly as possible. To receive system information (system information carried by a broadcast channel and system information scheduled by a common control channel), paging message and so on broadcasted on the anchor sub-bands, the narrowband UEs may need to jump back to the anchor sub-bands in a particular period and monitor information of a broadcast type. The common control channel is a physical downlink control channel carrying scheduling information for broadcasted messages, such as system information or paging message. As it takes lots of actions to jump back and forth between the anchor sub-bands and the other sub-bands (an entire radio frequency link needs to be adjusted), the particular period may be relatively long.

As it takes lots of actions to jump back and forth between the anchor sub-bands and the other sub-bands, power consumption of the narrowband UEs is relatively great, and system efficiency is relatively low.

Therefore, a new radio transmission method is required.

### SUMMARY

In embodiments of the present disclosure, partial bandwidth radio transmission method and device, a base station and a user equipment are provided, which enables a UE to use partial bandwidth among a relatively large system bandwidth to receive and transmit data and improves system efficiency.

In an embodiment, a partial bandwidth radio transmission method is provided, including: configuring a first common control channel transmitted on an anchor sub-band; configuring at least one sub-band other than anchor sub-bands, and a second common control channel transmitted on the at least one sub-band; scheduling at least one partial bandwidth UE to the at least one sub-band, and transmitting configuration of the second common control channel and the at least one sub-band to the at least one partial bandwidth UE; and obtaining a transmission time of a synchronization signal block in the anchor sub-band, and transmitting the second common control channel to the at least one sub-band based on the transmission time of the synchronization signal block, wherein the second common control channel includes a reference signal Z for demodulation.

Optionally, the second common control channel and the synchronization signal block are transmitted through a same beam, or the second common control channel and the first common control channel are transmitted through a same beam.

Optionally, the second common control channel and the synchronization signal block being transmitted through a same beam, or the second common control channel and the first common control channel being transmitted through a same beam includes: binding an antenna port of a synchronization signal in the synchronization signal block, an antenna port of a reference signal X of a broadcast channel in the synchronization signal block, or an antenna port of a reference signal Y of the first common control channel to an antenna port of the reference signal Z of the second common control channel, to make the second common control channel and the synchronization signal block share a quasi co-location or to make the second common control channel and the first common control channel share a quasi co-location.

Optionally, the second common control channel and the synchronization signal block being transmitted through a same beam, or the second common control channel and the first common control channel being transmitted through a same beam includes: obtaining a number of an antenna port of a synchronization signal in the synchronization signal block, a number of an antenna port of a reference signal X of a broadcast channel in the synchronization signal block, or a number of an antenna port of a reference signal Y of the first common control channel; and configuring a number of an antenna port of the reference signal Z of the second common control channel with the number of the antenna port of the synchronization signal in the synchronization signal block, the number of the antenna port of the reference signal X, or the number of the antenna port of the reference signal Y.

Optionally, transmitting configuration of the second common control channel to the at least one partial bandwidth UE may include: indicating a time domain position or a frequency domain position of the second common control channel via a Radio Resource Control (RRC) signaling, a Media Access Control (MAC) control entity or downlink control information.

Optionally, indicating a time domain position of the second common control channel via an RRC signaling, a MAC control entity or downlink control information may include: obtaining a period of a burst set of the synchronization signal block in the anchor sub-band; and determining a transmission period of the second common control channel to be K times of the period of the burst set of the synchronization signal block in the anchor sub-band, wherein K is greater than or equal to 1.

Optionally, indicating a time domain position of the second common control channel via an RRC signaling, a MAC control entity or downlink control information may include: obtaining a transmission period of the first common control channel; and determining a transmission period of the second common control channel to be L times of the transmission period of the first common control channel, wherein L is greater than or equal to 1.

Optionally, transmitting configuration of the second common control channel to the at least one partial bandwidth UE may include: obtaining the reference signal Y; and configuring the reference signal Z to have a same pattern as the reference signal Y.

Optionally, transmitting configuration of the at least one sub-band to the at least one partial bandwidth UE may include: indicating a frequency domain position, a numerology and a time slot structure of the at least one sub-band via an RRC signaling, a MAC control entity or downlink control information.

In an embodiment, a partial bandwidth radio transmission device is provided, including: a scheduling circuitry, configured to schedule at least one UE to at least one sub-band other than anchor sub-bands; a configuring circuitry, configured to configure the at least one sub-band and a second common control channel transmitted on the at least one sub-band, and transmit configuration of the second common control channel and the at least one sub-band to the at least one UE; a determining circuitry, configured to determine a time point for transmitting the second common control channel to the at least one sub-band based on a transmission time of a synchronization signal block in an anchor sub-band; and a transmitting circuitry, configured to transmit the second common control channel to the at least one sub-band, wherein the second common control channel includes a reference signal Z for demodulation.

Optionally, the device may include: an obtaining circuitry, configured to obtain a number of an antenna port of a synchronization signal in the synchronization signal block, a number of an antenna port of a reference signal X of a broadcast channel in the synchronization signal block, or a number of an antenna port of a reference signal Y of a first common control channel transmitted on the anchor sub-band; and a beam sharing circuitry, configured to bind the antenna port of the synchronization signal, the antenna port of the reference signal X, or the antenna port of the reference signal Y to an antenna port of the reference signal Z of the second common control channel, to make the second common control channel and the synchronization signal block share a quasi co-location or to make the second common control channel and the first common control channel share a quasi co-location; or configure the number of the antenna port of the reference signal Z with the number of the antenna port of the synchronization signal, the number of the antenna port of the reference signal X, or the number of the antenna port of the reference signal Y.

Optionally, the device may further include: an indicating circuitry, configured to indicate a time domain position or a frequency domain position of the second common control channel via an RRC signaling, a MAC control entity or downlink control information, or indicate a frequency domain position, a numerology and a time slot structure of the at least one sub-band via an RRC signaling, a MAC control entity or downlink control information.

Optionally, the device may further include: a setting circuitry, configured to configure the reference signal Z to have a same pattern and a same mapping relation between ports and resources as the reference signal Y.

In an embodiment, a base station is provided, including the above partial bandwidth radio transmission device.

In an embodiment, a partial bandwidth radio transmission method is provided, including: reporting capability of supporting partial bandwidth to a network; decoding an RRC signaling, a MAC control entity or downlink control signal; obtaining a time domain position and a frequency domain position of a second common control channel, and a frequency domain position, a numerology and a time slot structure of at least one sub-band other than anchor sub-bands, wherein the second common control channel is transmitted on the at least one sub-band; performing time and frequency tracking, beam tracking and measurement to a reference signal Z of the second common control channel on the at least one sub-band; and monitoring a radio link based on the measurement.

Optionally, monitoring a radio link based on the measurement may include: determining whether a measured value of the reference signal Z is smaller than a predetermined value; if the measured value of the reference signal Z is smaller than the predetermined value, initiating a radio link reconstruction mechanism; and if the measured value of the reference signal Z is not smaller than the predetermined value, not initiating the radio link reconstruction mechanism.

Optionally, a frequency domain position, a numerology and a time slot structure of the at least one sub-band are obtained, and data is received and transmitted based on the frequency domain position, the numerology and the time slot structure.

Optionally, the capability of supporting partial bandwidth is reported to the network during a process of setting up connection with the network.

In an embodiment, a partial bandwidth radio transmission device is provided, including: a decoding circuitry, configured to decode an RRC signaling, a MAC control entity or downlink control signal; an obtaining circuitry, configured to obtain a time domain position and a frequency domain position of a second common control channel, and a frequency domain position, a numerology and a time slot structure of at least one sub-band other than anchor sub-bands, wherein the second common control channel is transmitted on the at least one sub-band; a measuring circuitry, configured to perform time and frequency tracking, beam tracking and measurement to a reference signal Z of the second common control channel on the at least one sub-band; and a monitoring circuitry, configured to monitor a radio link based on the measurement.

Optionally, the device may further include: an information receiving and transmitting circuitry, configured to receive and transmit data based on the frequency domain position, the numerology and the time slot structure of the at least one sub-band.

In an embodiment, a partial bandwidth UE is provided, including the above partial bandwidth radio transmission device.

In embodiments of the present disclosure, the second common control channel is transmitted to the at least one sub-band other than anchor sub-bands at the transmission time of the synchronization signal block in the anchor sub-band, wherein the second common control channel includes the reference signal for demodulation. After the configuration of the second common control channel and the at least one sub-band is transmitted to UE, the UE may receive and transmit data using partial bandwidth among a relatively large system bandwidth, which may improve system efficiency and realize reasonable utilization of resources.

### BRIEF DESCRIPTION OF THE DRAWINGS

FIG. 1 schematically illustrates a flow chart of a partial bandwidth radio transmission method according to an embodiment.

FIG. 2 schematically illustrates a flow chart of a partial bandwidth radio transmission method according to an embodiment.

FIG. 3 schematically illustrates a structural diagram of a partial bandwidth radio transmission device according to an embodiment.

FIG. 4 schematically illustrates a flow chart of a partial bandwidth radio transmission method according to an embodiment.

FIG. 5 schematically illustrates a flow chart of a partial bandwidth radio transmission method according to an embodiment.

FIG. 6 schematically illustrates a structural diagram of a partial bandwidth radio transmission device according to an embodiment.

FIG. 7 schematically illustrates a diagram of a partial bandwidth radio transmission method according to an embodiment.

### DETAILED DESCRIPTION

In order to clarify the object, solutions and advantages of embodiments of the present disclosure, embodiments of present disclosure will be described clearly in detail in conjunction with accompanying drawings. The following embodiments are only a portion of embodiments of the present disclosure. Other embodiments obtained by those skilled in the art without creative efforts based on the following embodiments belong to scope of the present disclosure.

Embodiments of the present disclosure may be applied in a 5G system, and signals and channels used for detection and primary cell selection may include Primary Synchronization Signal (PSS), Secondary Synchronization Signal (SSS) and broadcast channels, which are similar with PSS, SSS and Physical Broadcast Channel (PBCH) in an LTE system or different from existing channels in the LTE system.

Besides, a Physical Downlink Control Channel (PDCCH) may include PPS, SSS and broadcast channels, which are similar with PSS, SSS and Physical Broadcast Channel (PBCH) in an LTE system or different from existing channels in the LTE system.

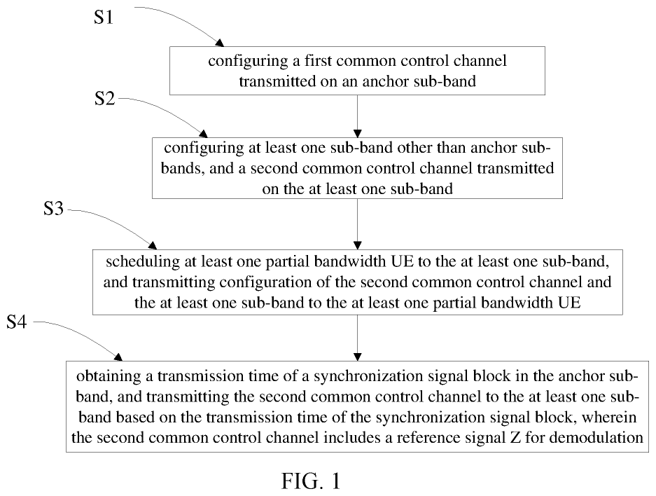

FIG. 1 schematically illustrates a flow chart of a partial bandwidth radio transmission method according to an embodiment.

Referring to FIG. 1, the method may include: configuring a first common control channel transmitted on an anchor sub-band; configuring at least one sub-band other than anchor sub-bands, and a second common control channel transmitted on the at least one sub-band; scheduling at least one partial bandwidth UE to the at least one sub-band, and transmitting configuration of the second common control channel and the at least one sub-band to the at least one partial bandwidth UE; and obtaining a transmission time of a synchronization signal block in the anchor sub-band, and transmitting the second common control channel to the at least one sub-band based on the transmission time of the synchronization signal block, wherein the second common control channel includes a reference signal Z for demodulation.

In the partial bandwidth radio transmission method provided in the embodiment of the present disclosure, the anchor sub-band is located in a 5G system, a base station transmits the synchronization signal block and the first common control channel on a particular sub-band of a relatively large bandwidth, wherein the synchronization signal block includes the synchronization signal and a broadcast channel. For example, the base station transmits the synchronization signal, the broadcast channel and the first common control channel on a 20 MHz sub-band in the middle of a 100 MHz system bandwidth. The synchronization signal, the broadcast channel and the first common control channel transmitted on the anchor sub-band may also be used for time and frequency tracking (i.e., synchronization), beam tracking and receiving information of broadcast type by the UE. In addition to the anchor sub-band, there are other sub-bands (i.e., sub-bands other than anchor sub-bands). For example, in addition to the 20 MHz anchor sub-band, there are also four other 20 MHz sub-bands in the 100 MHz system bandwidth. In the embodiments of the present disclosure, the UE uses the other sub-bands (i.e., sub-bands other than anchor sub-bands) to transmit and receive data.

In embodiments of the present disclosure, the second common control channel is transmitted to the at least one sub-band other than anchor sub-bands at the transmission time of the synchronization signal block in the anchor sub-band, wherein the second common control channel includes the reference signal for demodulation. After the configuration of the second common control channel and the at least one sub-band is transmitted to UE, the UE may receive and transmit data using partial bandwidth among a relatively large system bandwidth, which may improve system efficiency and realize reasonable utilization of resources.

Besides, the common control channel in embodiments of the present disclosure is a type of physical downlink control channel, and frequency domain resources occupied by the common control channel may also be called a control resource set or a common control resource set of a physical downlink control channel, or a control sub-band.

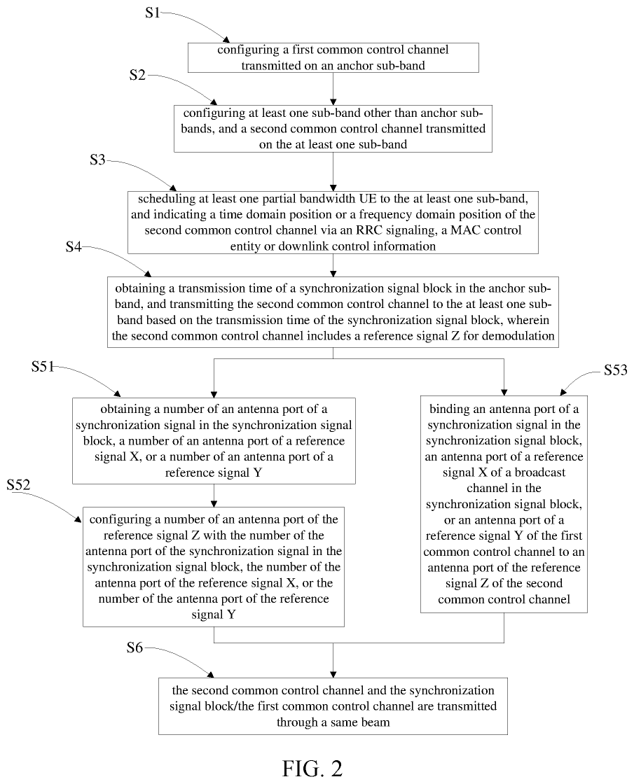

In some embodiments, referring to FIG. 2, the second common control channel and the synchronization signal block are transmitted through a same beam, or the second common control channel and the first common control channel are transmitted through a same beam.

In some embodiments, the second common control channel and the synchronization signal block being transmitted through a same beam, or the second common control channel and the first common control channel being transmitted through a same beam includes: binding an antenna port of a synchronization signal in the synchronization signal block, an antenna port of a reference signal X of a broadcast channel in the synchronization signal block, or an antenna port of a reference signal Y of the first common control channel to an antenna port of the reference signal Z of the second common control channel, to make the second common control channel and the synchronization signal block share a quasi co-location or to make the second common control channel and the first common control channel share a quasi co-location.

In some embodiments, the second common control channel and the synchronization signal block being transmitted through a same beam, or the second common control channel and the first common control channel being transmitted through a same beam further includes: obtaining a number of an antenna port of the synchronization signal in the synchronization signal block, a number of an antenna port of the reference signal X, or a number of an antenna port of the reference signal Y; and configuring a number of an antenna port of the reference signal Z with the number of the antenna port of the synchronization signal in the synchronization signal block, the number of the antenna port of the reference signal X, or the number of the antenna port of the reference signal Y.

Referring to FIG. 7, in some embodiments, transmitting configuration of the second common control channel to the at least one partial bandwidth UE may include: indicating a time domain position or a frequency domain position of the second common control channel via an RRC signaling, a MAC control entity or downlink control information.

In some embodiments, indicating a time domain position of the second common control channel via an RRC signaling, a MAC control entity or downlink control information may include: obtaining a period of a burst set of the synchronization signal block in the anchor sub-band; and determining a transmission period of the second common control channel to be K times of the period of the burst set of the synchronization signal block in the anchor sub-band, wherein K is greater than or equal to 1.

From above, in embodiments of the present disclosure, the transmission period of the second common control channel is determined based on a network status, which may improve resource utilization.

In some embodiments, indicating a time domain position of the second common control channel via an RRC signaling, a MAC control entity or downlink control information may include: obtaining a transmission period of the first common control channel; and determining a transmission period of the second common control channel to be L times of the transmission period of the first common control channel, wherein L is greater than or equal to 1.

In some embodiments, transmitting configuration of the second common control channel to the at least one partial bandwidth UE may include: obtaining the reference signal Y; and configuring the reference signal Z to have a same pattern as the reference signal Y.

In embodiments of the present disclosure, the reference signal Z has a same pattern as the reference signal Y, which enables better time and frequency tracking, beam tracking and measurement of the reference signal Z on the at least one sub-band other than anchor sub-bands.

In some embodiments, transmitting configuration of the at least one sub-band to the at least one partial bandwidth UE may include: indicating a frequency domain position, a numerology and a time slot structure of the at least one sub-band via an RRC signaling, a MAC control entity or downlink control information.

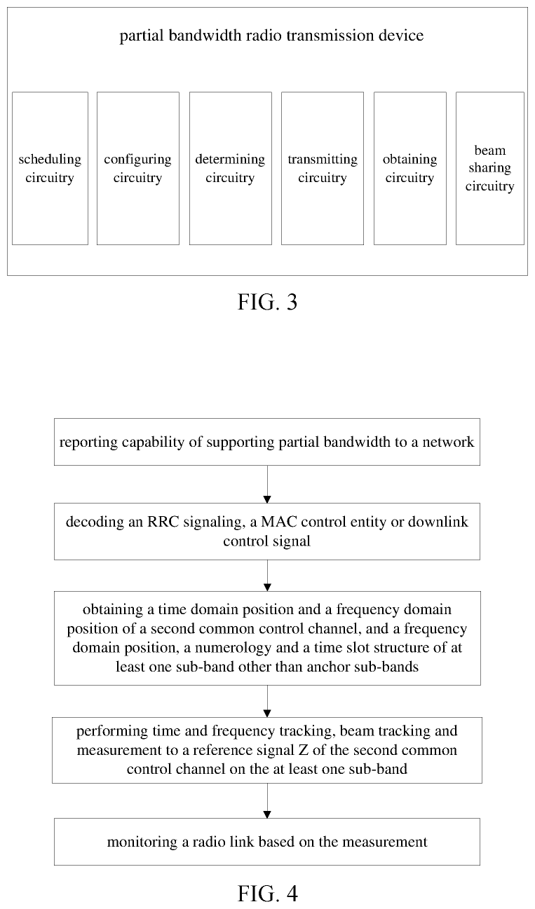

In an embodiment, a partial bandwidth radio transmission device is provided. Referring to FIG. 3, the device includes: a scheduling circuitry, configured to schedule at least one UE to at least one sub-band other than anchor sub-bands; a configuring circuitry, configured to configure the at least one sub-band and a second common control channel transmitted on the at least one sub-band, and transmit configuration of the second common control channel and the at least one sub-band to the at least one UE; a determining circuitry, configured to determine a time point for transmitting the second common control channel to the at least one sub-band based on a transmission time of a synchronization signal block in an anchor sub-band; and a transmitting circuitry, configured to transmit the second common control channel to the at least one sub-band, wherein the second common control channel includes a reference signal Z for demodulation.

In the partial bandwidth radio transmission device provided in embodiments of the present disclosure, the determining circuitry determines the transmission time of the synchronization signal block in the anchor sub-band, and the transmission circuitry transmits the second common control channel to the at least one sub-band other than anchor sub-bands at the transmission time of the synchronization signal block in the anchor sub-band, wherein the second common control channel includes the reference signal for demodulation. In this way, after the configuration of the second common control channel and the at least one sub-band is transmitted to UE, the UE may receive and transmit data using partial bandwidth among a relatively large system bandwidth, which may improve system efficiency and realize reasonable utilization of resources.

In some embodiments, the device may include: an obtaining circuitry, configured to obtain a number of an antenna port of a synchronization signal in the synchronization signal block, a number of an antenna port of a reference signal X of a broadcast channel in the synchronization signal block, or a number of an antenna port of a reference signal Y of a first common control channel transmitted on the anchor sub-band; and a beam sharing circuitry, configured to bind the antenna port of the synchronization signal, the antenna port of the reference signal X, or the antenna port of the reference signal Y to an antenna port of the reference signal Z of the second common control channel, to make the second common control channel and the synchronization signal block share a quasi co-location or to make the second common control channel and the first common control channel share a quasi co-location; or configure the number of the antenna port of the reference signal Z with the number of the antenna port of the synchronization signal, the number of the antenna port of the reference signal X, or the number of the antenna port of the reference signal Y.

In some embodiments, the device may further include: an indicating circuitry, configured to indicate a time domain position or a frequency domain position of the second common control channel via an RRC signaling, a MAC control entity or downlink control information, or indicate a frequency domain position, a numerology and a time slot structure of the at least one sub-band via an RRC signaling, a MAC control entity or downlink control information.

In some embodiments, the device may further include: a setting circuitry, configured to configure the reference signal Z to have a same pattern and a same mapping relation between ports and resources as the reference signal Y.

In an embodiment, a base station is provided, including the above partial bandwidth radio transmission device.

In an embodiment, a partial bandwidth radio transmission method is provided, which is applied in a UE.

Referring to FIG. 4, the method includes: reporting capability of supporting partial bandwidth to a network; decoding an RRC signaling, a MAC control entity or downlink control signal; obtaining a time domain position and a frequency domain position of a second common control channel, and a frequency domain position, a numerology and a time slot structure of at least one sub-band other than anchor sub-bands, wherein the second common control channel is transmitted on the at least one sub-band; performing time and frequency tracking, beam tracking and measurement to a reference signal Z of the second common control channel on the at least one sub-band; and monitoring a radio link based on the measurement.

By the partial bandwidth radio transmission method provided in embodiments of the present disclosure, when UEs use partial bandwidth to receive and transmit data, the UEs camp on the anchor sub-band in an idle state; when the UEs enter a connection state, a base station schedules at least one partial bandwidth UE to the at least one sub-band other than anchor sub-bands, and transmits the configuration of the second common control channel and the at least one sub-band to the at least one partial bandwidth UE. In existing techniques, in order to receive from an anchor sub-band a synchronization signal block, a first common control channel and so on at other sub-bands, UE needs to jump back to the anchor sub-band in a particular period and obtain the synchronization signal block, the first common control channel and so on. As it takes lots of actions to jump back and forth between the anchor sub-bands and the other sub-bands, the particular period may be relatively long, which causes relatively low system efficiency when the UE receives and transmits data using partial bandwidth.

Therefore, in embodiments of the present disclosure, the second common control channel is transmitted to the at least one sub-band other than anchor sub-bands at the transmission time of the synchronization signal block in the anchor sub-band, wherein the second common control channel includes the reference signal for demodulation. The UE decodes the RRC signaling, the MAC control entity or the downlink control information to obtain the time domain position or the frequency domain position of the second common control channel, or the frequency domain position, the numerology and the time slot structure of the at least one sub-band. Then, the UE performs time and frequency tracking (to achieve a synchronization function), beam tracking and measurement to the reference signal Z on the at least one sub-band, which avoids jumping back to the anchor sub-band to perform synchronization, beam tracking and measurement on, and further improves efficiency of the at least one sub-band.

Besides, a radio link may be monitored based on the measurement, and whether the radio link is normal is determined by the monitoring, which may further improve the system efficiency.

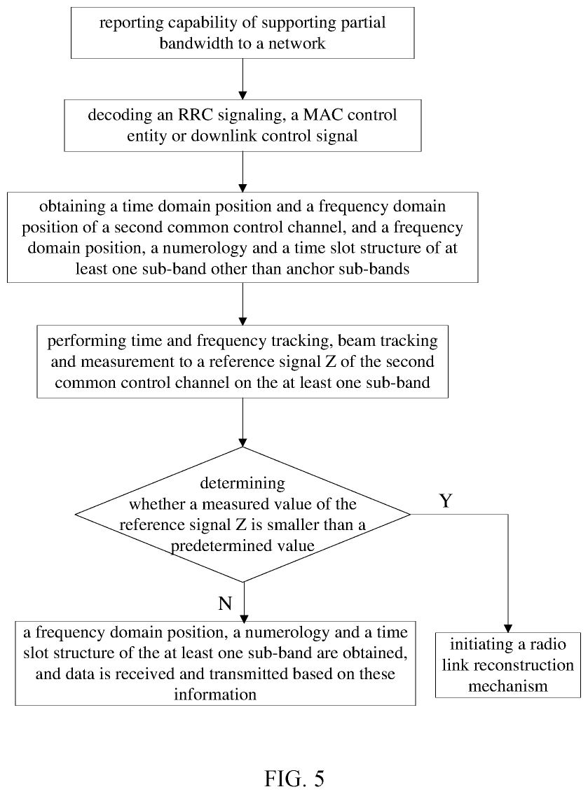

Referring to FIG. 5, in some embodiments, monitoring the radio link based on the measurement may include: determining whether a measured value of the reference signal Z is smaller than a predetermined value; if the measured value of the reference signal Z is smaller than the predetermined value, initiating a radio link reconstruction mechanism; and if the measured value of the reference signal Z is not smaller than the predetermined value, not initiating the radio link reconstruction mechanism.

In some embodiments, a frequency domain position, a numerology and a time slot structure of the at least one sub-band are obtained, and data is received and transmitted based on the frequency domain position, the numerology and the time slot structure.

In some embodiments, the capability of supporting partial bandwidth is reported to the network during a process of setting up connection with the network.

In an embodiment, a partial bandwidth radio transmission device is provided, which is applied in a UE.

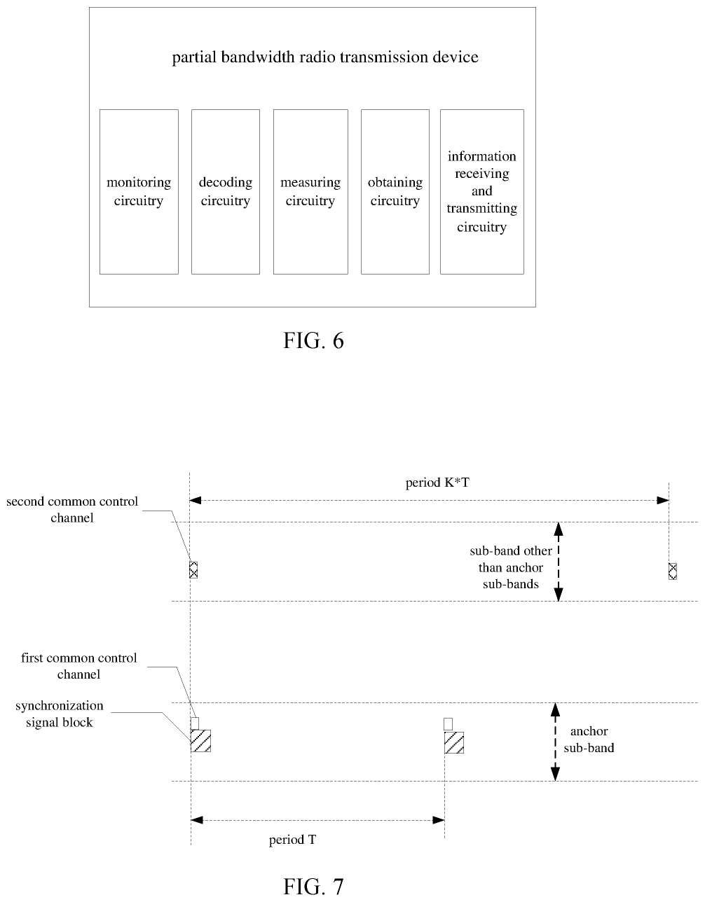

Referring to FIG. 6, the device includes: a decoding circuitry, configured to decode an RRC signaling, a MAC control entity or downlink control signal; an obtaining circuitry, configured to obtain a time domain position and a frequency domain position of a second common control channel, and a frequency domain position, a numerology and a time slot structure of at least one sub-band other than anchor sub-bands, wherein the second common control channel is transmitted on the at least one sub-band; a measuring circuitry, configured to perform time and frequency tracking, beam tracking and measurement to a reference signal Z of the second common control channel on the at least one sub-band; and a monitoring circuitry, configured to monitor a radio link based on the measurement.

In some embodiments, the device may further include: an information receiving and transmitting circuitry, configured to receive and transmit data based on the frequency domain position, the numerology and the time slot structure of the at least one sub-band.

The partial bandwidth radio transmission device provided in the embodiment shown in FIG. 6 may be used for implementing the method provided in the embodiment shown in FIG. 4 and FIG. 5. Implementing principles and technical effects of the device are similar with those of the above-mentioned method and are not described in detail here.

In an embodiment, a partial bandwidth UE is provided, including the above partial bandwidth radio transmission device which is applied in the method and skilled in the art can understand that all of or a portion of the processes in the method provided in the above embodiments can be implemented by related hardware with instruction of computer program. The computer program may be stored in a readable storage medium, such as a magnetic disk, an optical disk, a Read-Only Memory (ROM) or a Random Access Memory (RAM).

Although the present disclosure has been disclosed above with reference to preferred embodiments thereof, it should be understood that the disclosure is presented by way of example only, and not limitation. Those skilled in the art can modify and vary the embodiments without departing from the spirit and scope of the present disclosure.

What is claimed is:

1. A partial bandwidth radio transmission method, comprising:
decoding a Radio Resource Control (RRC) signaling, a Media Access Control (MAC) control entity or downlink control signal; and
obtaining a frequency domain position, a numerology and a time slot structure of at least one sub-band other than anchor sub-bands and obtaining a time domain position and a frequency domain position of a second common control channel transmitted on the at least one sub-band other than the anchor sub-bands.

2. The method according to claim 1, further comprising reporting capability of supporting partial bandwidth to a network.

3. The method according to claim 2, further comprising:
performing time and frequency tracking, beam tracking and measurement to a reference signal Z of the second common control channel on the at least one sub-band other than the anchor sub-bands; and
monitoring a radio link based on the measurement.

4. The method according to claim 3, wherein said monitoring the radio link based on the measurement comprises:
determining whether a measured value of the reference signal Z is smaller than a predetermined value;
if the measured value of the reference signal Z is smaller than the predetermined value, initiating a radio link reconstruction mechanism; and
if the measured value of the reference signal Z is not smaller than the predetermined value, not initiating the radio link reconstruction mechanism.

5. The method according to claim 1, wherein data is received and transmitted based on the frequency domain position, the numerology and the time slot structure of the at least one sub-band other than the anchor sub-bands.

6. The method according to claim 2, wherein the capability of supporting partial bandwidth is reported to the network during a process of setting up connection with the network.

7. A partial bandwidth User Equipment (UE) comprising a memory and a processor, wherein the memory stores one or more programs, the one or more programs comprising computer instructions, which, when executed by the processor, cause the processor to:
decode a Radio Resource Control (RRC) signaling, a Media Access Control (MAC) control entity or downlink control signal; and
obtain a frequency domain position, a numerology and a time slot structure of at least one sub-band other than anchor sub-bands and obtain a time domain position and a frequency domain position of a second common control channel transmitted on the at least one sub-band other than the anchor sub-bands.

8. The partial bandwidth UE according to claim 7, wherein the processor is further caused to report capability of supporting partial bandwidth to a network.

9. The partial bandwidth UE according to claim 8, wherein the processor is further caused to:
perform time and frequency tracking, beam tracking and measurement to a reference signal Z of the second common control channel on the at least one sub-band other than the anchor sub-bands; and
monitor a radio link based on the measurement.

10. The partial bandwidth UE according to claim 9, wherein the processor is further caused to:
determine whether a measured value of the reference signal Z is smaller than a predetermined value;
if the measured value of the reference signal Z is smaller than the predetermined value, initiate a radio link reconstruction mechanism; and
if the measured value of the reference signal Z is not smaller than the predetermined value, not initiate the radio link reconstruction mechanism.

11. The partial bandwidth UE according to claim 7, wherein data is received and transmitted based on the frequency domain position, the numerology and the time slot structure of the at least one sub-band other than the anchor sub-bands.

12. The partial bandwidth UE according to claim 8, wherein the capability of supporting partial bandwidth is reported to the network during a process of setting up connection with the network.

13. A computer readable storage medium storing one or more programs, the one or more programs comprising computer instructions, which, when executed by a processor, cause the processor to:
decode a Radio Resource Control (RRC) signaling, a Media Access Control (MAC) control entity or downlink control signal; and
obtain a frequency domain position, a numerology and a time slot structure of at least one sub-band other than anchor sub-bands and obtain a time domain position and a frequency domain position of a second common control channel transmitted on the at least one sub-band other than the anchor sub-bands.

14. The computer readable storage medium according to claim 13, wherein the processor is further caused to report capability of supporting partial bandwidth to a network.

15. The computer readable storage medium according to claim 14, wherein the processor is further caused to:
perform time and frequency tracking, beam tracking and measurement to a reference signal Z of the second common control channel on the at least one sub-band other than the anchor sub-bands; and
monitor a radio link based on the measurement.

16. The computer readable storage medium according to claim 15, wherein the processor is further caused to:
determine whether a measured value of the reference signal Z is smaller than a predetermined value;
if the measured value of the reference signal Z is smaller than the predetermined value, initiate a radio link reconstruction mechanism; and
if the measured value of the reference signal Z is not smaller than the predetermined value, not initiate the radio link reconstruction mechanism.

17. The computer readable storage medium according to claim 13, wherein data is received and transmitted based on the frequency domain position, the numerology and the time slot structure of the at least one sub-band other than the anchor sub-bands.

18. The computer readable storage medium according to claim 14, wherein the capability of supporting partial bandwidth is reported to the network during a process of setting up connection with the network.
